(19) United States
(12) Patent Application Publication
(10) Pub. No.: US 2022/0334387 A1
(43) Pub. Date: Oct. 20, 2022

(54) MULTI-USER MULTIVIEW DISPLAY, SYSTEM AND METHOD

(71) Applicant: LEIA INC., Menlo Park, CA (US)

(72) Inventor: David A. Fattal, Menlo Park, CA (US)

(21) Appl. No.: 17/857,989

(22) Filed: Jul. 5, 2022

Related U.S. Application Data
(63) Continuation of application No. PCT/US2021/013835, filed on Jan. 18, 2021.
(60) Provisional application No. 62/963,493, filed on Jan. 20, 2020.

(51) Int. Cl. G02B 27/00; G02B 30/33; F21V 8/00

(52) U.S. Cl. CPC G02B 27/0093; G02B 30/33; G02B 6/0036; G02B 6/0076

(57) ABSTRACT

A multi-user multiview display, system, and method selectively provide either a multiview image when a group of users is within a predefined viewing zone or a two-dimensional (2D) image when the group of users is outside of the predefined viewing zone. The multi-user multiview display includes a broad-angle backlight configured to provide broad-angle emitted light and a multiview backlight configured to directional emitted light. The multi-user multiview display further includes an array of light valves configured to modulate the broad-angle emitted light to provide the 2D image and to modulate the directional emitted light to provide the multiview image within a predefined viewing zone. A head tracker may be employed to track users of the group of user to determine whether or not to provide the multiview image or the 2D image based on a location of the group of users.

### CROSS-REFERENCE TO RELATED APPLICATIONS

This application is a continuation application of and claims priority to International Patent Application No. PCT/US2021/013835, filed Jan. 18, 2021, which claims the benefit of priority to U.S. Provisional Patent Application Ser. No. 62/963,493, filed Jan. 20, 2020, the entirety of both of which is incorporated by reference herein.

### STATEMENT REGARDING FEDERALLY SPONSORED RESEARCH OR DEVELOPMENT

N/A

### BACKGROUND

Electronic displays are a nearly ubiquitous medium for communicating information to users of a wide variety of devices and products. Among the most commonly found electronic displays are the cathode ray tube (CRT), plasma display panels (PDP), liquid crystal displays (LCD), electroluminescent displays (EL), organic light-emitting diode (OLED) and active matrix OLEDs (AMOLED) displays, electrophoretic displays (EP) and various displays that employ electromechanical or electrofluidic light modulation (e.g., digital micromirror devices, electrowetting displays, etc.). In general, electronic displays may be categorized as either active displays (i.e., displays that emit light) or passive displays (i.e., displays that modulate light provided by another source). Among the most obvious examples of active displays are CRTs, PDPs and OLEDs/AMOLEDs. Displays that are typically classified as passive when considering emitted light are LCDs and EP displays. Passive displays, while often exhibiting attractive performance characteristics including, but not limited to, inherently low power consumption, may find somewhat limited use in many practical applications given the lack of an ability to emit light.

### BRIEF DESCRIPTION OF THE DRAWINGS

Various features of examples and embodiments in accordance with the principles described herein may be more readily understood with reference to the following detailed description taken in conjunction with the accompanying drawings, where like reference numerals designate like structural elements, and in which:

FIG. 1A illustrates a perspective view of a multiview display in an example, according to an embodiment consistent with the principles described herein.

FIG. 1B illustrates a graphical representation of the angular components of a light beam having a particular principal angular direction in an example, according to an embodiment consistent with the principles described herein.

FIG. 2A illustrates a side view of a multi-user multiview display in an example, according to an embodiment consistent with the principles described herein.

FIG. 2B illustrates a side view of the multi-user multiview display of FIG. 2A in another example, according to an embodiment consistent with the principles described herein.

FIG. 3A illustrates a cross-sectional view of a multi-user multiview display in an example, according to an embodiment consistent with the principles described herein.

FIG. 3B illustrates a cross-sectional view of a multi-user multiview display in another example, according to an embodiment consistent with the principles described herein.

FIG. 3C illustrates a perspective view of a multi-user multiview display in an example, according to an embodiment consistent with the principles described herein.

FIG. 4 illustrates a cross-sectional view of a broad-angle backlight in an example, according to an embodiment consistent with the principles described herein.

FIG. 5 illustrates a cross-sectional view of a multi-user multiview display in an example, according to an embodiment consistent with the principles described herein.

FIG. 6 illustrates a block diagram of a multi-user multiview display system in an example, according to an embodiment consistent with the principles described herein.

FIG. 7 illustrates a flow chart of a method of multi-user multiview display operation in an example, according to an embodiment consistent with the principles described herein.

Certain examples and embodiments may have other features that are one of in addition to and in lieu of the features illustrated in the above-referenced figures. These and other features are detailed below with reference to the above-referenced figures.

### DETAILED DESCRIPTION

Examples and embodiments in accordance with the principles described herein provide multiview displaying of information to multiple users as well as methods of operation thereof. In particular, in accordance with the principles described herein, a multi-user multiview display is configured to selectively provide a multiview image when a group of users is within a predefined viewing zone of the multi-user multiview display. Otherwise, a two-dimensional (2D) image may be provided by the multi-user multiview display when the group of users is outside of the predefined viewing zone. By selectively providing either the multiview image or the 2D image based on whether or not the group of users are within the predefined viewing zone may ensure that users of the multi-user multiview display are provided with a comfortable viewing experience that is substantially without jumps and bad spots within an angular viewing range of the multiview image, according to various embodiments. Uses of multi-user multiview displays and display systems described herein include, but are not limited to, mobile telephones (e.g., smart phones), watches, tablet computes, mobile computers (e.g., laptop computers), personal computers and computer monitors, automobile display consoles, camera displays, and various other mobile as well as substantially non-mobile display applications and devices.

Herein a ‘two-dimensional display’ or ‘2D display’ is defined as a display configured to provide a view of an image that is substantially the same regardless of a direction from which the image is viewed (i.e., within a predefined viewing angle or range of the 2D display). A liquid crystal display (LCD) found in many smart phones and computer monitors are examples of 2D displays. In contrast herein, a ‘multiview display’ is defined as an electronic display or display system configured to provide different views of a multiview image in or from different view directions. In particular, the different views may represent different perspective views of a scene or object of the multiview image. In some instances, a multiview display may also be referred to as a three-dimensional (3D) display, e.g., when simultaneously viewing two different views of the multiview image provides a perception of viewing a three-dimensional image. For example, the multi-user multiview display may provide multiview images that are so-called ‘glasses-free’ or autostereoscopic images.

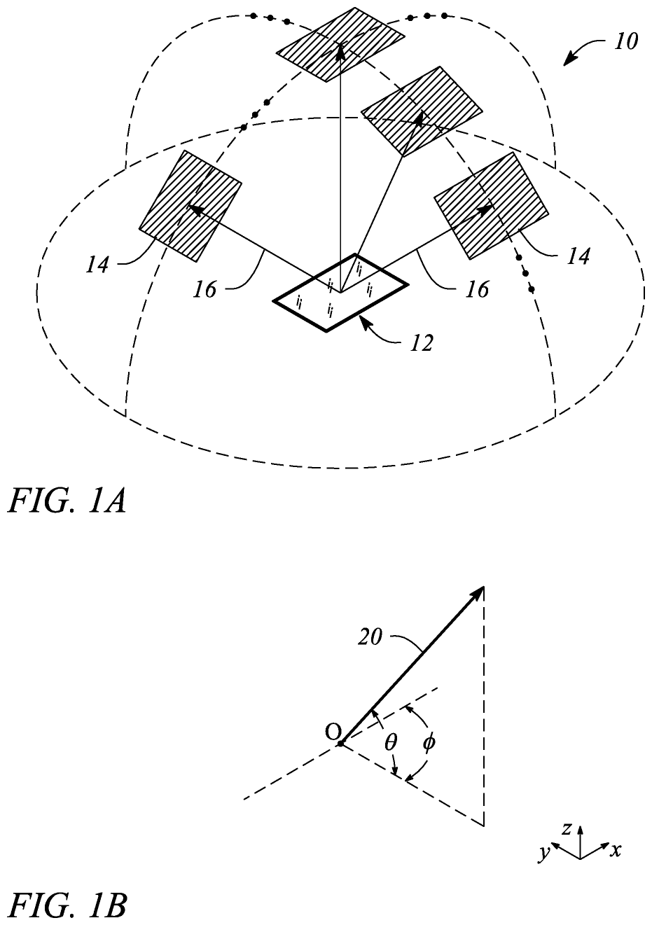

FIG. 1A illustrates a perspective view of a multiview display 10 in an example, according to an embodiment consistent with the principles described herein. As illustrated in FIG. 1A, the multiview display 10 comprises a screen 12 to display a multiview image to be viewed. The multiview display 10 provides different views 14 of the multiview image in different view directions 16 relative to the screen 12. The view directions 16 are illustrated as arrows extending from the screen 12 in various different principal angular directions; the different views 14 are illustrated as shaded polygonal boxes at the termination of the arrows (i.e., depicting the view directions 16); and only four views 14 and four view directions 16 are illustrated, all by way of example and not limitation. Note that while the different views 14 are illustrated in FIG. 1A as being above the screen, the views 14 actually appear on or in a vicinity of the screen 12 when the multiview image is displayed on the multiview display 10. Depicting the views 14 above the screen 12 is only for simplicity of illustration and is meant to represent viewing the multiview display 10 from a respective one of the view directions 16 corresponding to a particular view 14.

A view direction or equivalently a light beam having a direction corresponding to a view direction of a multiview display generally has a principal angular direction given by angular components {θ, ϕ}, by definition herein. The angular component θ is referred to herein as the ‘elevation component’ or ‘elevation angle’ of the light beam. The angular component ϕ is referred to as the ‘azimuth component’ or ‘azimuth angle’ of the light beam. By definition, the elevation angle θ is an angle in a vertical plane (e.g., perpendicular to a plane of the multiview display screen while the azimuth angle ϕ is an angle in a horizontal plane (e.g., parallel to the multiview display screen plane).

FIG. 1B illustrates a graphical representation of the angular components {θ, ϕ} of a light beam 20 having a particular principal angular direction or simply ‘direction’ corresponding to a view direction (e.g., view direction 16 in FIG. 1A) of a multiview display in an example, according to an embodiment consistent with the principles described herein. In addition, the light beam 20 is emitted or emanates from a particular point, by definition herein. That is, by definition, the light beam 20 has a central ray associated with a particular point of origin within the multiview display. FIG. 1B also illustrates the light beam (or view direction) point of origin, O.

Herein, the term ‘multiview’ as used in the terms ‘multiview image’ and ‘multiview display’ is defined as a plurality of views representing different perspectives or including angular disparity between views of the view plurality. In addition, herein the term ‘multiview’ explicitly includes more than two different views (i.e., a minimum of three views and generally more than three views), by definition herein. As such, ‘multiview display’ as employed herein is explicitly distinguished from a stereoscopic display that includes only two different views to represent a scene or an image. Note however, while multiview images and multiview displays may include more than two views, by definition herein, multiview images may be viewed (e.g., on a multiview display) as a stereoscopic pair of images by selecting only two of the multiview views to view at a time (e.g., one view per eye).

A ‘multiview pixel’ is defined herein as a set of sub-pixels or ‘view’ pixels in each of a similar plurality of different views of a multiview display. In particular, a multiview pixel may have individual view pixels corresponding to or representing a view pixel in each of the different views of the multiview image. Moreover, the view pixels of the multiview pixel are so-called ‘directional pixels’ in that each of the view pixels is associated with a predetermined view direction of a corresponding one of the different views, by definition herein. Further, according to various examples and embodiments, the different view pixels of a multiview pixel may have equivalent or at least substantially similar locations or coordinates in each of the different views. For example, a first multiview pixel may have individual view pixels located at {x₁y₁} in each of the different views of a multiview image, while a second multiview pixel may have individual view pixels located at {x₂y₂} in each of the different views, and so on. In some embodiments, a number of view pixels in a multiview pixel may be equal to a number of views of the multiview display.

Herein, a ‘multiview image’ is defined as a plurality of images (i.e., greater than three images) wherein each image of the plurality represents a different view corresponding to a different view direction of the multiview image. As such, the multiview image is a collection of images (e.g., two-dimensional images) which, when display on a multiview display, may facilitate a perception of depth and thus appear to be an image of a 3D scene to a viewer, for example.

Further herein, a ‘user’ of a display is defined as one who is or may be using or viewing the display. As such, a user of a multiview display is, by definition, a viewer of the multiview display that may be viewing a multiview image displayed on or by the multiview display, for example. Further, the terms ‘user’ and ‘viewer’ may be used interchangeably herein to refer to a user of a display. In addition, herein a ‘group of users’ is explicitly defined as one or more users.

According to various embodiments, a multiview display may have an angular viewing range that is constrained to a subregion of a half-space above the multiview display. The subregion corresponding to this angular viewing range is defined herein as a ‘predefined viewing zone I’ and represents the subregion of the half-space in which a user may view a multiview image displayed by the multiview without experiencing or substantially encountering image jumps or so-called ‘bad spots’ associated with the displaying a multiview image on or by the multiview display.

Herein, a ‘light guide’ is defined as a structure that guides light within the structure using total internal reflection (TIR). In particular, the light guide may include a core that is substantially transparent at an operational wavelength of the light guide. In various examples, the term ‘light guide’ generally refers to a dielectric optical waveguide that employs total internal reflection to guide light at an interface between a dielectric material of the light guide and a material or medium that surrounds that light guide. By definition, a condition for total internal reflection is that a refractive index of the light guide is greater than a refractive index of a surrounding medium adjacent to a surface of the light guide material. In some embodiments, the light guide may include a coating in addition to or instead of the aforementioned refractive index difference to further facilitate the total internal reflection. The coating may be a reflective coating, for example. The light guide may be any of several light guides including, but not limited to, one or both of a plate or slab guide and a strip guide.

The term ‘plate’ when applied to a light guide as in a ‘plate light guide’ herein is defined as a piecewise or differentially planar layer or sheet, which is sometimes referred to as a ‘slab’ guide. In particular, a plate light guide is defined as a light guide configured to guide light in two substantially orthogonal directions bounded by a top surface and a bottom surface (i.e., opposite surfaces) of the light guide. Further, by definition herein, the top and bottom surfaces are both separated from one another and may be substantially parallel to one another in at least a differential sense. That is, within any differentially small section of the plate light guide, the top and bottom surfaces are substantially parallel or co-planar.

In some embodiments, the plate light guide may be substantially flat (i.e., confined to a plane) and therefore, the plate light guide is a planar light guide. In other embodiments, the plate light guide may be curved in one or two orthogonal dimensions. For example, the plate light guide may be curved in a single dimension to form a cylindrical shaped plate light guide. However, any curvature has a radius of curvature sufficiently large to ensure that total internal reflection is maintained within the plate light guide to guide light.

As defined herein, a ‘non-zero propagation angle’ of guided light is an angle relative to a guiding surface of a light guide. Further, the non-zero propagation angle is both greater than zero and less than a critical angle of total internal reflection within the light guide, by definition herein. Moreover, a specific non-zero propagation angle may be chosen (e.g., arbitrarily) for a particular implementation as long as the specific non-zero propagation angle is less than the critical angle of total internal reflection within the light guide. In various embodiments, the light may be introduced or coupled into the light guide 122 at the non-zero propagation angle of the guided light.

According to various embodiments, guided light or equivalently a guided ‘light beam’ produced by coupling light into the light guide may be a collimated light beam. Herein, a ‘collimated light’ or ‘collimated light beam’ is generally defined as a beam of light in which rays of the light beam are substantially parallel to one another within the light beam. Further, rays of light that diverge or are scattered from the collimated light beam are not considered to be part of the collimated light beam, by definition herein.

Herein, a ‘collimation factor’ is defined as a degree to which light is collimated. In particular, a collimation factor defines an angular spread of light rays within a collimated beam of light, by definition herein. For example, a collimation factor σ may specify that a majority of light rays in a beam of collimated light is within a particular angular spread (e.g., +/−σ degrees about a central or principal angular direction of the collimated light beam). The light rays of the collimated light beam may have a Gaussian distribution in terms of angle and the angular spread may be an angle determined by at one-half of a peak intensity of the collimated light beam, according to some examples.

Further herein, a ‘collimator’ is defined as substantially any optical device or apparatus that is configured to collimate light. For example, a collimator may include, but is not limited to, a collimating mirror or reflector, a collimating lens, a diffraction grating, a tapered light guide, and various combinations thereof. According to various embodiments, an amount of collimation provided by the collimator may vary in a predetermined degree or amount from one embodiment to another. Further, the collimator may be configured to provide collimation in one or both of two orthogonal directions (e.g., a vertical direction and a horizontal direction). That is, the collimator may include a shape or similar collimating characteristic in one or both of two orthogonal directions that provides light collimation, according to some embodiments.

By definition herein, a ‘multibeam element’ is a structure or element of a backlight or a display that produces light that includes a plurality of light beams. In some embodiments, the multibeam element may be optically coupled to a light guide of a backlight to provide the plurality of light beams by coupling or scattering out a portion of light guided in the light guide. Further, the light beams of the plurality of light beams produced by a multibeam element have different principal angular directions from one another, by definition herein. In particular, by definition, a light beam of the plurality has a predetermined principal angular direction that is different from another light beam of the light beam plurality. As such, the light beam is referred to as a ‘directional light beam’ and the light beam plurality may be termed a ‘directional light beam plurality,’ by definition herein.

Furthermore, the directional light beam plurality may represent a light field. For example, the directional light beam plurality may be confined to a substantially conical region of space or have a predetermined angular spread that includes the different principal angular directions of the light beams in the light beam plurality. As such, the predetermined angular spread of the light beams in combination (i.e., the light beam plurality) may represent the light field.

According to various embodiments, the different principal angular directions of the various directional light beams of the plurality are determined by a characteristic including, but not limited to, a size (e.g., length, width, area, etc.) of the multibeam element. In some embodiments, the multibeam element may be considered an ‘extended point light source’, i.e., a plurality of point light sources distributed across an extent of the multibeam element, by definition herein. Further, a directional light beam produced by the multibeam element has a principal angular direction given by angular components {θ, ϕ}, by definition herein, and described above with respect to FIG. 1B.

Herein, a ‘light source’ is defined as a source of light (e.g., an optical emitter configured to produce and emit light). For example, the light source may comprise an optical emitter such as a light emitting diode (LED) that emits light when activated or turned on. In particular, herein the light source may be substantially any source of light or comprise substantially any optical emitter including, but not limited to, one or more of a light emitting diode (LED), a laser, an organic light emitting diode (OLED), a polymer light emitting diode, a plasma-based optical emitter, a fluorescent lamp, an incandescent lamp, and virtually any other source of light. The light produced by the light source may have a color (i.e., may include a particular wavelength of light), or may be a range of wavelengths (e.g., white light). In some embodiments, the light source may comprise a plurality of optical emitters. For example, the light source may include a set or group of optical emitters in which at least one of the optical emitters produces light having a color, or equivalently a wavelength, that differs from a color or wavelength of light produced by at least one other optical emitter of the set or group. The different colors may include primary colors (e.g., red, green, blue) for example. A ‘polarized’ light source is defined herein as substantially any light source that produces or provides light having a predetermined polarization. For example, the polarized light source may comprise a polarizer at an output of an optical emitter of the light source.

By definition herein, ‘broad-angle’ emitted light is defined as light having a cone angle that is greater than a cone angle of the view of a multiview image or multiview display. In particular, in some embodiments, the broad-angle emitted light may have a cone angle that is greater than about twenty degrees (e.g., >±20°). In other embodiments, the broad-angle emitted light cone angle may be greater than about thirty degrees (e.g., >±30°), or greater than about forty degrees (e.g., >±40°), or greater than about fifty degrees (e.g., >±50°). For example, the cone angle of the broad-angle emitted light may be greater than about sixty degrees (e.g., >±60°).

In some embodiments, the broad-angle emitted light cone angle may defined to be about the same as a viewing angle of an LCD computer monitor, an LCD tablet, an LCD television, or a similar digital display device meant for broad-angle viewing (e.g., about ±40-65°). In other embodiments, broad-angle emitted light may also be characterized or described as diffuse light, substantially diffuse light, non-directional light (i.e., lacking any specific or defined directionality), or as light having a single or substantially uniform direction.

Embodiments consistent with the principles described herein may be implemented using a variety of devices and circuits including, but not limited to, one or more of integrated circuits (ICs), very large scale integrated (VLSI) circuits, application specific integrated circuits (ASIC), field programmable gate arrays (FPGAs), digital signal processors (DSPs), graphical processor unit (GPU), and the like, firmware, software (such as a program module or a set of instructions), and a combination of two or more of the above. For example, an embodiment or elements thereof may be implemented as circuit elements within an ASIC or a VLSI circuit. Implementations that employ an ASIC or a VLSI circuit are examples of hardware-based circuit implementations.

In another example, an embodiment may be implemented as software using a computer programming language (e.g., C/C++) that is executed in an operating environment or a software-based modeling environment (e.g., MATLAB®, MathWorks, Inc., Natick, Mass.) that is further executed by a computer (e.g., stored in memory and executed by a processor or a graphics processor of a general purpose computer). Note that one or more computer programs or software may constitute a computer-program mechanism, and the programming language may be compiled or interpreted, e.g., configurable or configured (which may be used interchangeably in this discussion), to be executed by a processor or a graphics processor of a computer.

In yet another example, a block, a module or an element of an apparatus, device or system (e.g., image processor, camera, etc.) described herein may be implemented using actual or physical circuitry (e.g., as an IC or an ASIC), while another block, module or element may be implemented in software or firmware. In particular, according to the definitions herein, some embodiments may be implemented using a substantially hardware-based circuit approach or device (e.g., ICs, VLSI, ASIC, FPGA, DSP, firmware, etc.), while other embodiments may also be implemented as software or firmware using a computer processor or a graphics processor to execute the software, or as a combination of software or firmware and hardware-based circuitry, for example.

Further, as used herein, the article ‘a’ is intended to have its ordinary meaning in the patent arts, namely ‘one or more’. For example, ‘a multibeam element’ means one or more multibeam elements and as such, ‘the multibeam element’ means ‘the multibeam element(s)’ herein. Also, any reference herein to ‘top’, ‘bottom’, ‘upper’, ‘lower’, ‘up’, ‘down’, ‘front’, back’, ‘first’, ‘second’, ‘left’ or ‘right’ is not intended to be a limitation herein. Herein, the term ‘about’ when applied to a value generally means within the tolerance range of the equipment used to produce the value, or may mean plus or minus 10%, or plus or minus 5%, or plus or minus 1%, unless otherwise expressly specified. Further, the term ‘substantially’ as used herein means a majority, or almost all, or all, or an amount within a range of about 51% to about 100%. Moreover, examples herein are intended to be illustrative only and are presented for discussion purposes and not by way of limitation.

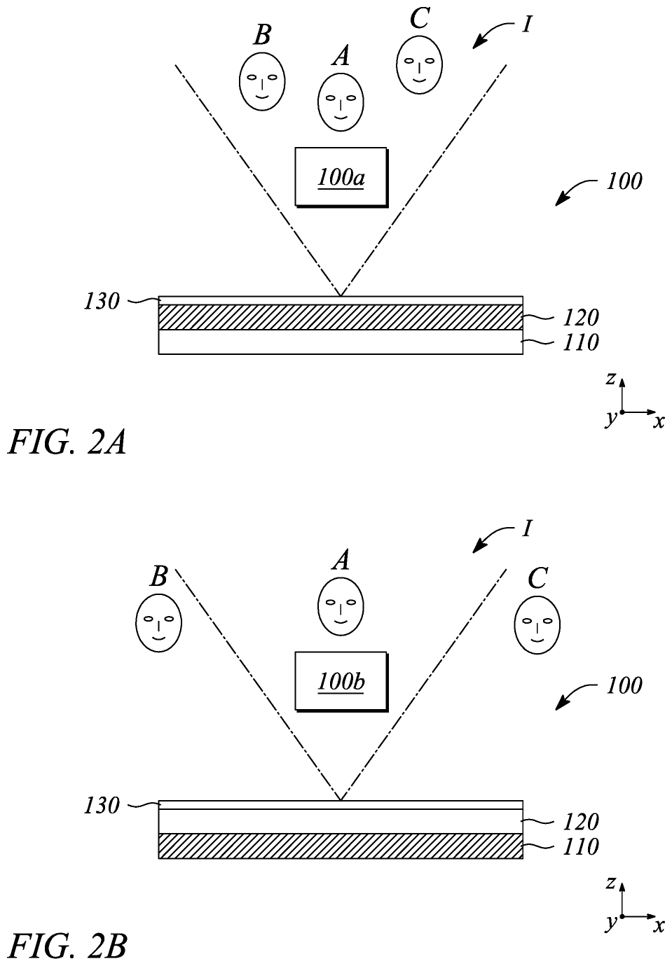

In accordance with some embodiments of the principles described herein, a multi-user multiview display is provided. FIG. 2A illustrates a side view of a multi-user multiview display 100 in an example, according to an embodiment consistent with the principles described herein. FIG. 2B illustrates a side view of the multi-user multiview display 100 of FIG. 2A in another example, according to an embodiment consistent with the principles described herein. As illustrated, the multi-user multiview display 100 is configured to selectively provide either a multiview image 100a or two-dimensional (2D) image 100b to be viewed by a group of users A, B, C. In particular, the multi-user multiview display 100 is configured to provide the multiview image 100a when the group of users A, B, C is within a predefined viewing zone I of the multi-user multiview display 100, as illustrated in FIG. 2A. That is, if locations of users A, B, C correspond to being within the predefined viewing zone I, the group of users A, B, C may be considered or determined to be within a predefined viewing zone I, according to various embodiments.

Alternatively, when the group of users A, B, C is outside of the predefined viewing zone I, as illustrated in FIG. 2B, the multi-user multiview display 100 is configured to provide the 2D image 100b. According to various embodiments, the group of users A, B, C may be determined or considered to be outside the predefined viewing zone I when one or more of the users A, B, C are not within the predefined viewing zone I, i.e., locations of one or more of the users A, B, C do not correspond to being within the predefined viewing zone I. FIG. 2B illustrates at least some of the users A, B, C of the group of users A, B, C outside the predefined viewing zone I, by way of example and not limitation.

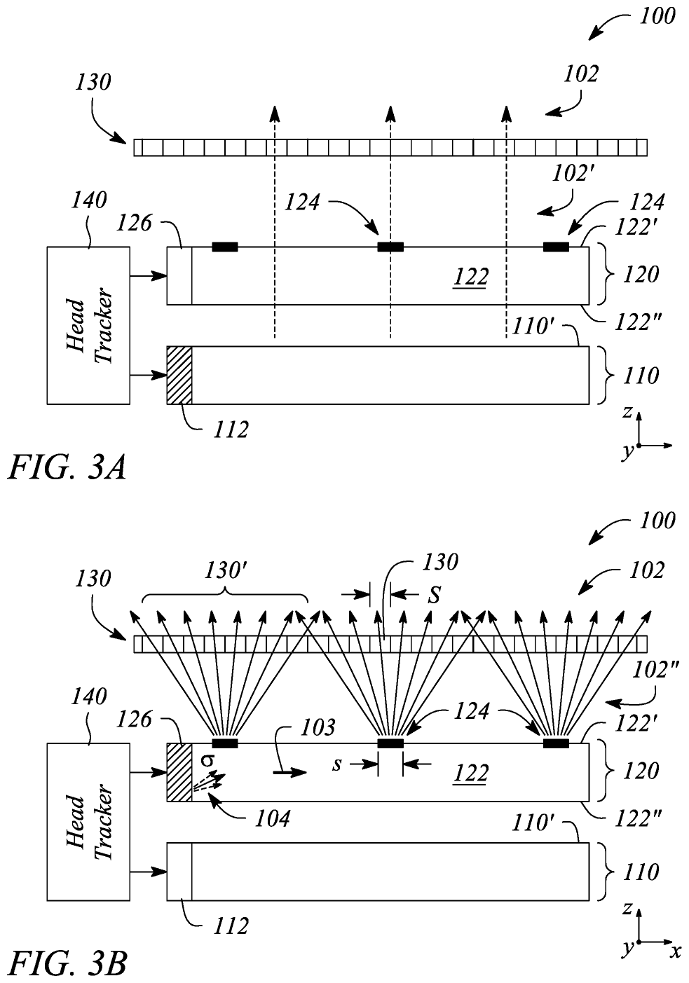

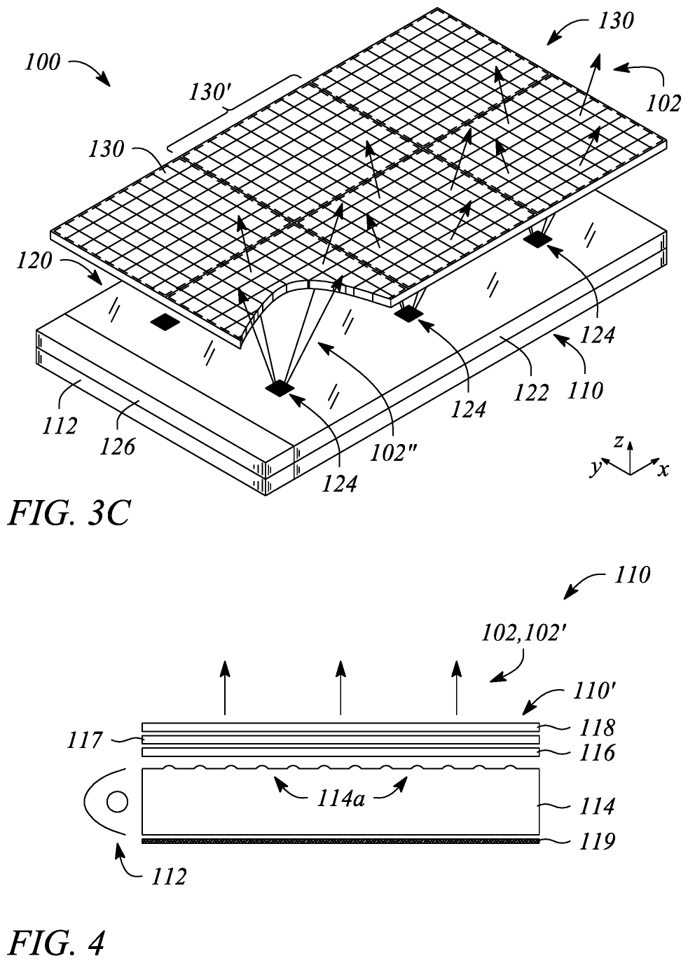

FIG. 3A illustrates a cross-sectional view of a multi-user multiview display 100 in an example, according to an embodiment consistent with the principles described herein. FIG. 3B illustrates a cross-sectional view of a multi-user multiview display 100 in another example, according to an embodiment consistent with the principles described herein. FIG. 3C illustrates a perspective view of a multi-user multiview display 100 in an example, according to an embodiment consistent with the principles described herein. In particular, FIG. 3A illustrates the multi-user multiview display 100 configured to provide or display a 2D image. FIGS. 3B and 3C illustrate the multi-user multiview display 100 configured to provide or display a multiview image. According to various embodiments, the multi-user multiview display 100 illustrated in FIGS. 3A-3C may be used to selectively provide either the 2D image or the multiview image to a group of users (e.g., the group of users A, B, C) of the multi-user multiview display 100, as described above with respect to FIGS. 2A-2B.

As illustrated, the multi-user multiview display 100 is configured to provide or emit light as emitted light 102. In turn, the emitted light 102 is used to illuminate an array of light valves (e.g., light valves 130, described below) of the multi-user multiview display 100. According to various embodiments, the light valve array is configured to modulate the emitted light 102 as or to provide an image that is displayed on or by the multi-user multiview display 100. Further, the multi-user multiview display 100 is configured to selectively display by modulating the emitted light 102 either a two-dimensional (2D) image or a multiview image. As described above, the 2D image and multiview image may be selectively provided or displayed based on a location of the group of users A, B, C, relative to the multi-user multiview display 100, according to various embodiments.

In particular, light emitted by the multi-user multiview display 100 as the emitted light 102 may comprise light that is either directional or substantially non-directional, depending on whether a multiview image or a 2D image is to be displayed. For example, as described below in more detail, multi-user multiview display 100 is configured to provide the emitted light 102 as broad-angle emitted light 102′ that is modulated by the light valve array to provide 2D images. Alternatively, the multi-user multiview display 100 is configured to provide the emitted light 102 as directional emitted light 102″ that is modulated by the light valve array to provide multiview images.

According to various embodiments, the directional emitted light 102″ comprises a plurality of directional light beams having principal angular directions that differ from one another. Further, directional light beams of the directional emitted light 102″ have directions corresponding to different view directions of the multiview image. Conversely, the broad-angle emitted light 102′ is largely non-directional and further generally has a cone angle that is greater than a cone angle of a view of the multiview image associated with or display by the multi-user multiview display 100, according to various embodiments.

In FIG. 3A, the broad-angle emitted light 102′ is illustrated as dashed arrows for ease of illustration. However, the dashed arrows representing the broad-angle emitted light 102′ are not meant to imply any particular directionality of the emitted light 102, but instead merely represent the emission and transmission of light, e.g., from the multi-user multiview display 100. Similarly, FIGS. 3B and 3C illustrate the directional light beams of the directional emitted light 102″ as a plurality of diverging arrows. As described above, the different principal angular directions of directional light beams of the directional emitted light 102″ correspond to respective view directions of a multiview image or equivalently of the multi-user multiview display 100. Further, the directional light beams may be or represent a light field, in various embodiments.

As illustrated in FIGS. 3A-3C, the multi-user multiview display 100 comprises a broad-angle backlight 110. The illustrated broad-angle backlight 110 has a planar or substantially planar light-emitting surface 110′ configured to provide the broad-angle emitted light 102′ (e.g., see FIG. 3A). According to various embodiments, the broad-angle backlight 110 may be substantially any backlight having a light-emitting surface 110′ configured to provide light to illuminate an array of light valves of a display. For example, the broad-angle backlight 110 may be a direct-emitting or directly illuminated planar backlight. Direct-emitting or directly illuminated planar backlights include, but are not limited to, a backlight panel employing a planar array of cold-cathode fluorescent lamps (CCFLs), neon lamps or light emitting diodes (LEDs) configured to directly illuminate the planar light-emitting surface 110′ and provide the broad-angle emitted light 102′. An electroluminescent panel (ELP) is another non-limiting example of a direct-emitting planar backlight. In other examples, the broad-angle backlight 110 may comprise a backlight that employs an indirect light source. Such indirectly illuminated backlights may include, but are not limited to, various forms of edge-coupled or so-called ‘edge-lit’ backlights.

FIG. 4 illustrates a cross-sectional view of a broad-angle backlight 110 in an example, according to an embodiment consistent with the principles described herein. As illustrated in FIG. 4, the broad-angle backlight 110 is an edge-lit backlight and comprises a light source 112 coupled to an edge of the broad-angle backlight 110. The edge-coupled light source 112 is configured to produce light within the broad-angle backlight 110. Further, as illustrated by way of example and not limitation, the broad-angle backlight 110 comprises a guiding structure 114 (or light guide) having a substantially rectangular cross section with parallel opposing surfaces (i.e., a rectangular-shaped guiding structure) along with a plurality of extraction features 114a. The broad-angle backlight 110 illustrated in FIG. 4 comprises extraction features 114a at a surface (i.e., top surface) of the guiding structure 114 of the broad-angle backlight 110, by way of example and not limitation. Light from the edge-coupled light source 112 and guided within the rectangular-shaped guiding structure 114 may be redirected, scattered out of or otherwise extracted from the guiding structure 114 by the extraction features 114a to provide the broad-angle emitted light 102′, according to various embodiments. The illustrated broad-angle backlight 110 of FIG. 4 may be activated by turning on the edge-coupled light source 112, e.g., also illustrated in FIG. 3A using cross-hatching of the light source 112, for example.

In some embodiments, the broad-angle backlight 110, whether direct-emitting or edge-lit (e.g., as illustrated in FIG. 4), may further comprise one or more additional layers or films including, but not limited to, a diffuser or diffusion layer, a brightness enhancement film (BEF), and a polarization recycling film or layer. For example, a diffuser may be configured to increase an emission angle of the broad-angle emitted light 102′ when compared to that provided by the extraction features 114a alone. The brightness enhancement film may be used to increase an overall brightness of the broad-angle emitted light 102′, in some examples. Brightness enhancement films (BEF) are available, for example, from 3M Optical Systems Division, St. Paul, Minn. as a Vikuiti™ BEF II which are micro-replicated enhancement films that utilize a prismatic structure to provide up to a 60% brightness gain. The polarization recycling layer may be configured to selectively pass a first polarization while reflecting a second polarization back toward the rectangular-shaped guiding structure 114. The polarization recycling layer may comprise a reflective polarizer film or dual brightness enhancement film (DBEF), for example. Examples of DBEF films include, but are not limited to, 3M Vikuiti™ Dual Brightness Enhancement Film available from 3M Optical Systems Division, St. Paul, Minn. In another example, an advanced polarization conversion film (APCF) or a combination of brightness enhancement and APCF films may be employed as the polarization recycling layer.

FIG. 4 illustrates the broad-angle backlight 110 further comprising a diffuser 116 adjacent to guiding structure 114 and the planar light-emitting surface 110′ of the broad-angle backlight 110. Further, illustrated in FIG. 4 are a brightness enhancement film 117 and a polarization recycling layer 118, both of which are also adjacent to the planar light-emitting surface 110′. In some embodiments, the broad-angle backlight 110 further comprises a reflective layer 119 adjacent to a surface of the guiding structure 114 opposite to the planar light-emitting surface 110′ (i.e., on a back surface), e.g., as illustrated in FIG. 4. The reflective layer 119 may comprise any of a variety of reflective films including, but not limited to, a layer of reflective metal or an enhanced specular reflector (ESR) film. Examples of ESR films include, but are not limited to, a Vikuiti™ Enhanced Specular Reflector Film available from 3M Optical Systems Division, St. Paul, Minn.

Referring again to FIGS. 3A-3C, the multi-user multiview display 100 further comprises a multiview backlight 120. As illustrated, the multiview backlight 120 comprises an array of multibeam elements 124. Multibeam elements 124 of the multibeam element array are spaced apart from one another across the multiview backlight 120, according to various embodiments. For example, in some embodiments, the multibeam elements 124 may be arranged in a one-dimensional (1D) array. In other embodiments, the multibeam elements 124 may be arranged in a two-dimensional (2D) array. Further, differing types of multibeam elements 124 may be utilized in the multiview backlight 120 including, but limited to, active emitters and various scattering elements. According to various embodiments, each multibeam element 124 of the multibeam element array is configured to provide a plurality of directional light beams having directions corresponding to different view directions of the multiview image.

In some embodiments (e.g., as illustrated), the multiview backlight 120 further comprises a light guide 122 configured to guide light as guided light 104. The light guide 122 may be a plate light guide, in some embodiments. According to various embodiments, the light guide 122 is configured to guide the guided light 104 along a length of the light guide 122 according to total internal reflection. A general propagation direction 103 of the guided light 104 within the light guide 122 is illustrated by a bold arrow in FIG. 3B. In some embodiments, the guided light 104 may be guided in the propagation direction 103 at a non-zero propagation angle and may comprise collimated light that has or is collimated according to a predetermined collimation factor σ, as illustrated in FIG. 3B.

In various embodiments, the light guide 122 may include a dielectric material configured as an optical waveguide. The dielectric material may have a first refractive index that is greater than a second refractive index of a medium surrounding the dielectric optical waveguide. A difference in refractive indices is configured to facilitate total internal reflection of the guided light 104 according to one or more guided modes of the light guide 122, for example. In some embodiments, the light guide 122 may be a slab or plate optical waveguide comprising an extended, substantially planar sheet of optically transparent, dielectric material. According to various examples, the optically transparent material of the light guide 122 may include or be made up of any of a variety of dielectric materials including, but not limited to, one or more of various types of glass (e.g., silica glass, alkali-aluminosilicate glass, borosilicate glass, etc.) and substantially optically transparent plastics or polymers (e.g., poly(methyl methacrylate) or ‘acrylic glass’, polycarbonate, etc.). In some examples, the light guide 122 may further include a cladding layer (not illustrated) on at least a portion of a surface (e.g., one or both of the top surface and the bottom surface) of the light guide 122. The cladding layer may be used to further facilitate total internal reflection, according to some examples.

In embodiments that include the light guide 122, a multibeam element 124 of the multibeam element array may be configured to scatter out a portion of the guided light 104 from within the light guide 122 and to direct the scattered out portion away from a first surface 122′ or emission surface of the light guide 122 or equivalent from a first surface of the multiview backlight 120 to provide the directional emitted light 102″, as illustrated in FIG. 3B. For example, the guided light portion may be scattered out by the multibeam element 124 through the first surface 122′. Further, as illustrated in FIGS. 3A-3C, a second surface of the multiview backlight 120 opposite to the first surface may be adjacent to the planar light-emitting surface 110′ of the broad-angle backlight 110, according to various embodiments.

Note that the plurality of directional light beams of the directional emitted light 102″, as illustrated in FIG. 3B, is or represents the plurality of directional light beams having different principal angular directions, described above. That is, a directional light beam has a different principal angular direction from other directional light beams of the directional emitted light 102″, according to various embodiments. Further, the multiview backlight 120 may be substantially transparent (e.g., in at least the 2D mode) to allow the broad-angle emitted light 102′ from the broad-angle backlight 110 to pass or be transmitted through a thickness of the multiview backlight 120, as illustrated in FIG. 3A by the dashed arrows that originate at the broad-angle backlight 110 and subsequently pass through the multiview backlight 120. In other words, the broad-angle emitted light 102′ provided by the broad-angle backlight 110 is configured to be transmitted through the multiview backlight 120, e.g., by virtue of the multiview backlight transparency.

For example, the light guide 122 and the spaced apart plurality of multibeam elements 124 may allow light to pass through the light guide 122 through both the first surface 122′ and the second surface 122″. Transparency may be facilitated, at least in part, due to both the relatively small size of the multibeam elements 124 and the relatively large inter-element spacing of the multibeam element 124. Further, especially when the multibeam elements 124 comprise diffraction gratings as described below, the multibeam elements 124 may also be substantially transparent to light propagating orthogonal to the light guide surfaces 122′, 122″, in some embodiments. Thus, for example, light from the broad-angle backlight 110 may pass in the orthogonal direction through the light guide 122 with the multibeam element array of the multiview backlight 120, according to various embodiments.

In some embodiments (e.g., as illustrated in FIGS. 3A-3C), the multiview backlight 120 may further comprise a light source 126. As such, the multiview backlight 120 may be an edge-lit backlight, for example. According to various embodiments, the light source 126 is configured to provide the light to be guided within light guide 122. In particular, the light source 126 may be located adjacent to an entrance surface or end (input end) of the light guide 122. In various embodiments, the light source 126 may comprise substantially any source of light (e.g., optical emitter) including, but not limited to, one or more light emitting diodes (LEDs) or a laser (e.g., laser diode). In some embodiments, the light source 126 may comprise an optical emitter configured produce a substantially monochromatic light having a narrowband spectrum denoted by a particular color. In particular, the color of the monochromatic light may be a primary color of a particular color space or color model (e.g., a red-green-blue (RGB) color model). In other examples, the light source 126 may be a substantially broadband light source configured to provide substantially broadband or polychromatic light. For example, the light source 126 may provide white light. In some embodiments, the light source 126 may comprise a plurality of different optical emitters configured to provide different colors of light. The different optical emitters may be configured to provide light having different, color-specific, non-zero propagation angles of the guided light corresponding to each of the different colors of light. As illustrated in FIG. 3B, activation of the multiview backlight 120 may comprise activating the light source 126, illustrated using cross-hatching.

In some embodiments, the light source 126 may further comprise a collimator (not illustrated). The collimator may be configured to receive substantially uncollimated light from one or more of the optical emitters of the light source 126. The collimator is further configured to convert the substantially uncollimated light into collimated light. In particular, the collimator may provide collimated light having the non-zero propagation angle and being collimated according to a predetermined collimation factors, according to some embodiments. Moreover, when optical emitters of different colors are employed, the collimator may be configured to provide the collimated light having one or both of different, color-specific, non-zero propagation angles and having different color-specific collimation factors.

As illustrated in FIGS. 3A-3C, the multi-user multiview display 100 further comprises an array of light valves 130. In various embodiments, any of a variety of different types of light valves may be employed as the light valves 130 of the light valve array including, but not limited to, one or more of liquid crystal light valves, electrophoretic light valves, and light valves based on or employing electrowetting. Further, as illustrated, there may be one unique set of light valves 130 for each multibeam element 124 of the array of multibeam elements. The unique set of light valves 130 may correspond to a multiview pixel 130′ of the multi-user multiview display 100, for example. In turn, a light valve may correspond to or be a sub-pixel of the multiview pixel 130′.

As mentioned above and according to various embodiments, the multiview backlight 120 comprises the array of multibeam elements 124. According to some embodiments (e.g., as illustrated in FIGS. 3A-3C), multibeam elements 124 of the multibeam element array may be located at the first surface 122′ of the light guide 122 (e.g., adjacent to the first surface of the multiview backlight 120). In other embodiments (not illustrated), the multibeam elements 124 may be located at or on the second surface 122″ of the light guide 122 (e.g., adjacent to the second surface of the multiview backlight 120). In yet other embodiments (not illustrated), the multibeam elements 124 may be located within the light guide 122 between and spaced apart from the first and second surfaces 122′, 122″. The first surface 122′, as illustrated in FIGS. 3A-3C may be referred to as an emission surface as emitted light 102 is emitted through this surface, as illustrated. Further, a size of the multibeam element 124 is comparable to a size of a light valve 130 of the multi-user multiview display 100.

Herein, the ‘size’ may be defined in any of a variety of manners to include, but not be limited to, a length, a width or an area. For example, the size of a light valve 130 of the light valve array may be a length thereof and the comparable size of the multibeam element 124 may also be a length of the multibeam element 124. In another example, size may refer to an area such that an area of the multibeam element 124 may be comparable to an area of the light valve 130. In some embodiments, the size of the multibeam element 124 is comparable to the light valve size such that the multibeam element size is between about twenty-five percent (25%) and about two hundred percent (200%) of the light valve size. For example, if the multibeam element size is denoted ‘s’ and the light valve size is denoted ‘S’ (e.g., as illustrated in FIG. 3B), then the multibeam element size s may be given by equation (1) as

¼S≤s≤2S (1)

In other examples, the multibeam element size is greater than about fifty percent (50%) of the light valve size, or about sixty percent (60%) of the light valve size, or about seventy percent (70%) of the light valve size, or greater than about eighty percent (80%) of the light valve size, or greater than about ninety percent (90%) of the light valve size, and the multibeam element is less than about one hundred eighty percent (180%) of the light valve size, or less than about one hundred sixty percent (160%) of the light valve size, or less than about one hundred forty percent (140%) of the light valve size, or less than about one hundred twenty percent (120%) of the light valve size. For example, by ‘comparable size’, the multibeam element size may be between about seventy-five percent (75%) and about one hundred fifty (150%) of the light valve size. In another example, the multibeam element 124 may be comparable in size to the light valve where the multibeam element size is between about one hundred twenty-five percent (125%) and about eighty-five percent (85%) of the light valve size. According to some embodiments, the comparable sizes of the multibeam element 124 and the light valve may be chosen to reduce, or in some examples to minimize, dark zones between views of the multi-user multiview display 100, while at the same time reducing, or in some examples minimizing, an overlap between views of the multi-user multiview display 100 or equivalent of the multiview image.

Note that, as illustrated in FIG. 3B, the size (e.g. width) of a multibeam element 124 may correspond to a size (e.g., width) of a light valve 130 in the light valve array. In other examples, the multibeam element size may be defined as a distance (e.g., a center-to-center distance) between adjacent light valves 130 of the light valve array. For example, the light valves 130 may be smaller than the center-to-center distance between the light valves 130 in the light valve array. Further, a spacing between adjacent multibeam elements of the multibeam element array may be commensurate with a spacing between adjacent multiview pixels of the multi-user multiview display 100. For example, an inter-emitter distance (e.g., center-to-center distance) between a pair of adjacent multibeam elements 124 may be equal to an inter-pixel distance (e.g., a center-to-center distance) between a corresponding adjacent pair of multiview pixels, e.g., represented by sets of light valves of the array of light valves 130. As such, the multibeam element size may be defined as either the size of the light valve 130 itself or a size corresponding to the center-to-center distance between the light valves 130, for example.

In some embodiments, a relationship between the multibeam elements 124 of the plurality and corresponding multiview pixels 130′ (e.g., sets of light valves 130) may be a one-to-one relationship. That is, there may be an equal number of multiview pixels 130′ and multibeam elements 124. FIG. 3C explicitly illustrates by way of example the one-to-one relationship where each multiview pixel 130′ comprising a different set of light valves 130 is illustrated as surrounded by a dashed line. In other embodiments (not illustrated), the number of multiview pixels 130′ and multibeam elements 124 may differ from one another.

In some embodiments, an inter-element distance (e.g., center-to-center distance) between a pair of adjacent multibeam elements 124 of the plurality may be equal to an inter-pixel distance (e.g., a center-to-center distance) between a corresponding adjacent pair of multiview pixels 130′, e.g., represented by light valve sets. In other embodiments (not illustrated), the relative center-to-center distances of pairs of multibeam elements 124 and corresponding light valve sets may differ, e.g., the multibeam elements 124 may have an inter-element spacing (i.e., center-to-center distance) that is one of greater than or less than a spacing (i.e., center-to-center distance) between light valve sets representing multiview pixels 130′.

Further (e.g., as illustrated in FIG. 3B), each multibeam element 124 may be configured to provide directional emitted light 102″ to one and only one multiview pixel 130′, according to some embodiments. In particular, for a given one of the multibeam elements 124, the directional emitted light 102″ having different principal angular directions corresponding to the different views of the multi-user multiview display 100 are substantially confined to a single corresponding multiview pixel 130′ and the light valves 130 thereof, i.e., a single set of light valves 130 corresponding to the multibeam element 124, as illustrated in FIG. 3B. As such, each multibeam element 124 of the broad-angle backlight 110 provides a corresponding plurality of directional light beams of the directional emitted light 102″ that has a set of the different principal angular directions corresponding to the different views of the multiview image (i.e., the set of directional light beams contains a light beam having a direction corresponding to each of the different view directions).

Note that FIGS. 2A-2B also illustrate the multi-user multiview display 100 comprising the broad-angle backlight 110, the multiview backlight 120, and the array of light valves 130. As illustrated in FIG. 2A, the multiview backlight 120 is activated as illustrated using cross-hatching and the multiview image 100a is provided using the light valve array 130 to modulate the directional emitted light from the activated multiview backlight 120. In FIG. 2B, the broad-angle backlight 110 is activated as illustrated using cross-hatching and the 2D image 100b is provided by modulating the broad-angle emitted light from the activated broad-angle backlight 110 using the light valve array 130. Referring again to FIGS. 3A-3B, the multi-user multiview display 100 may further comprise a head tracker 140, in some embodiments. The head tracker 140 is configured to determine a position of users A, B, C of the group of users A, B, C, relative to the predefined view zone I of the multi-user multiview display 100. The head tracker 140 is further configured to selectively activate one of the broad-angle backlight 110 or the multiview backlight 120 based on the determined position of users A, B, C. Selective activation of the broad-angle backlight 110 is illustrated in FIG. 3A using cross-hatching of the light source 112. Selective activation of the multiview backlight 120 is illustrated by cross-hatching of the light source 126 in FIG. 3B. The multiview backlight 120 may be selectively activated by the head tracker 140 and the multiview image 100a selectively provided, in turn, when the group of users A, B, C is determined by the head tracker 140 to be within the predefined view zone I. Alternatively, the broad-angle backlight being activated and the 2D image being provided when the group of users is outside of the predefined view zone. The head tracker 140 may be part of a display controller (not illustrated FIGS. 2A-3C), for example. In particular, the head tracker 140 or the display controller comprising the head tracker 140 may also control the light valve array 130 to coordinate display of the either the 2D image or multiview image based on which of the broad-angle backlight 110 or the multiview backlight 120 is activated.

According to various embodiments, the head tracker 140 may comprise one or more of a light detection and ranging sensor, a time-of-flight sensor, and a camera configured to determine the position of the users A, B, C of the group of users A, B, C. For example, the head tracker 140 may comprise a camera configured to periodically capture an image of the group of users A, B, C. The head tracker 140 may further comprise an image processor configured to determine a position of users A, B, C of the group of users A, B, C (or equivalent of the group of user A, B, C) within the periodically captured image to provide periodic location measurement of the group of users A, B, C relative to the predefined viewing zone I of the multi-user multiview display 100. In some embodiments, the head tracker 140 may further comprise a motion sensor configured to track a relative motion of the multi-user multiview display 100 during the time intervals between the periodic location measurements to determine the relative motion of the multi-user multiview display 100. The relative motion may be used to provide an estimate of the location of the group of users A, B, C during the time intervals between the periodic location measurements, according to some embodiments.

In some embodiments (not illustrated), the predefined viewing zone I may be configured to be dynamically adjusted or tilted. Dynamic adjustment or tilting of the predefined viewing zone I may be provided by changing a location of a multiview pixel of the light valve array 130 relative to a location of a corresponding multibeam element 124 within the multibeam element array. The location of the multiview pixel may be changed by changing how light valves 130 are driven to provide the multiview image, for example. The predefined viewing zone I may be dynamically adjusted to keep the group of users A, B, C within the predefined viewing zone I, according to some embodiments. In particular, the predefined viewing zone may be dynamically adjusted or tilted toward a determined location of the group of users A, B, C. In some embodiments, the 2D image may be provided or displayed exclusively when the group of users A, B, C is beyond an adjustment range of the predefined viewing zone I. For example, there may be a maxim adjustment range or tilt of the predefined viewing zone I that is practical given an particular implementation of the multi-user multiview display 100. When the maxim adjustment range or tilt is exceeded, then the 2D image may be provided or displayed when the determined location of the group of users A, B, C, is beyond the maxim adjustment range or tilt.

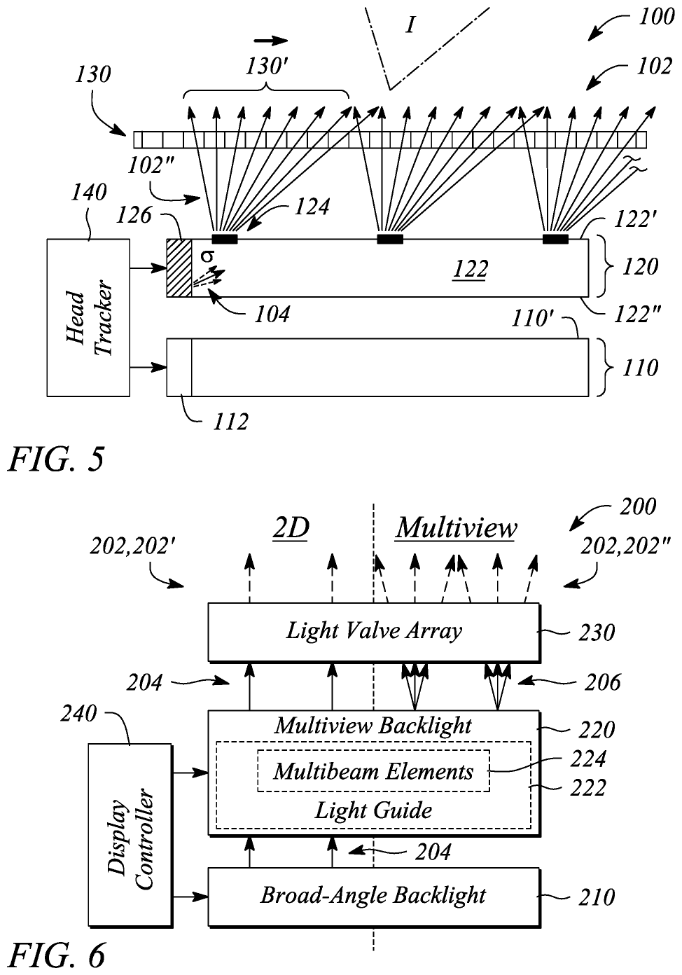

FIG. 5 illustrates a cross-sectional view of a multi-user multiview display 100 in an example, according to an embodiment consistent with the principles described herein. In particular, FIG. 5 illustrates the multi-user multiview display 100 of FIG. 3B in which a relative location of multiview pixel 130′ of the array of light valves 130 has been changed with respect to corresponding multibeam elements 124 to tilt the directional emitted light 102″ and likewise the predefined viewing zone I, e.g., the tilt may be toward the group of users (not illustrated). Changing of the multiview pixel 130′ relative location to tilt the predefined viewing zone I may be provided by the head tracker 140 or by a display controller (not illustrated) or by another control mechanism that controls the light valve array, e.g., by software. As such, the tilt in the predefined viewing zone I may provided without a physical change to the multi-user multiview display 100, according to some embodiments. A bold arrow in FIG. 5 illustrates change in the location of the multiview pixel 130′.

According to various embodiments, the multibeam elements 124 of the multiview backlight 120 may comprise any of a number of different structures configured to scatter out a portion of the guided light 104. For example, the different structures may include, but are not limited to, diffraction gratings, micro-reflective elements, micro-refractive elements, or various combinations thereof. In some embodiments, the multibeam element 124 comprising a diffraction grating is configured to diffractively couple or scatter out the guided light portion as the directional emitted light 102″ comprising a plurality of directional light beams having the different principal angular directions. In other embodiments, the multibeam element 124 comprising a micro-reflective element is configured to reflectively couple or scatter out the guided light portion as the plurality of directional light beams. In some embodiments the multibeam element 124 comprising a micro-refractive element is configured to couple or scatter out the guided light portion as the plurality of directional light beams by or using refraction (i.e., refractively scatter out the guided light portion).

In some embodiments, one or more of the diffraction grating, micro-reflective element, and micro-refractive element of the multibeam element comprises a plurality of sub-elements arranged within a boundary of the multibeam element. For example, sub-elements of the diffraction grating may comprise a plurality of diffractive sub-gratings. Similarly, the sub-elements of the micro-reflective element may comprise a plurality of micro-reflective sub-elements, while the sub-elements of the micro-refractive element may comprise a plurality of micro-reflective sub-elements.

According to some embodiments of the principles described herein, a the multi-user multiview display system is provided. The multi-user multiview display system is configured to selectively provide either a two-dimensional (2D) image or a multiview image, based on a location of users in or of a group of users. In particular, the multi-user multiview display system is configured to emit modulated light corresponding to or representing pixels of a 2D image comprising 2D information (e.g., 2D images, text, etc.). the multi-user multiview display system is further configured to emit modulated directional emitted light corresponding to or representing pixels of different views (view pixels) of a multiview image. Whether the 2D image or the multiview image is provided is determined based on whether the group of user is outside or within a predefined viewing zone of the multi-user multiview display system.

For example, the multi-user multiview display system may represent an autostereoscopic or glasses-free 3D electronic display when displaying or providing the multiview image. In particular, different ones of the modulated, differently directed light beams of the directional emitted light may correspond to different ‘views’ associated with the multiview information or multiview image, according to various examples. The different views may provide a ‘glasses free’ (e.g., autostereoscopic, holographic, etc.) representation of information being displayed by the multi-user multiview display system, for example.

FIG. 6 illustrates a block diagram of a multi-user multiview display system 200 in an example, according to an embodiment consistent with the principles described herein. The multi-user multiview display system 200 may be used to present as a composite image both 2D information and multiview information such as, but not limited to, 2D images, text, and multiview images, according to various embodiments. In particular, the multi-user multiview display system 200 illustrated in FIG. 6 is configured to emit modulated light 202 comprising modulated broad-angle emitted light 202′, the modulated broad-angle emitted light 202′ providing a 2D image (2D). Further, the multi-user multiview display system 200 illustrated in FIG. 6 is configured to emit modulated light 202 comprising modulated directional emitted light 202″ including directional light beams with different principal angular directions representing directional pixels to provide a multiview image (Multiview). In particular, the different principal angular directions may correspond to the different view directions of different views of the multiview image (Multiview) displayed by multi-user multiview display system 200.

As illustrated in FIG. 6, the multi-user multiview display system 200 comprises a broad-angle backlight 210. The broad-angle backlight 210 is configured to provide broad-angle emitted light 204. The broad-angle emitted light 204, when modulated as modulated broad-angle emitted light 202′, may be provided when a 2D image (2D) is to be displayed. In some embodiments, the broad-angle backlight 210 may be substantially similar to the broad-angle backlight 110 of the multi-user multiview display 100, described above. For example, the broad-angle backlight may comprise a light guide having a light extraction layer configured to extract light from the rectangular-shaped light guide and to redirect the extracted light through the diffuser as the broad-angle emitted light 204.

The multi-user multiview display system 200 illustrated in FIG. 6 further comprises a multiview backlight 220. As illustrated, the multiview backlight 220 comprises a light guide 222 and an array of multibeam elements 224 spaced apart from one another. The array of multibeam elements 224 is configured to scatter out guided light from the light guide 222 as directional emitted light 206 when a multiview image (Multiview) is to be displayed. According to various embodiments, the directional emitted light 206 provided by an individual multibeam element 224 of the array of multibeam elements 224 comprises a plurality of directional light beams having different principal angular directions corresponding to view directions of the multiview image (Multiview) displayed by the multi-user multiview display system 200.

In some embodiments, the multiview backlight 220 may be substantially similar to the multiview backlight 120 of the above-described multi-user multiview display 100. In particular, the light guide 222 and multibeam elements 224 may be substantially similar to the above-described the light guide 122 and multibeam elements 124, respectively. For example, the light guide 222 may be a plate light guide. In addition, the light guide may be configured to guide the guided light as collimated guided light having or according to a collimation factor. Further, a multibeam element 224 of the array of multibeam elements 224 may comprises one or more of a diffraction grating, a micro-reflective element and a micro-refractive element optically connected to the light guide 222 to scatter out the guided light as the directional emitted light 206, according to various embodiments.

As illustrated, the multi-user multiview display system 200 further comprises a light valve array 230. The light valve array 230 is configured to modulate the broad-angle emitted light 204 to provide a 2D image (2D) and to modulate the directional emitted light 206 to provide a multiview image (Multiview). In particular, the light valve array 230 is configured to receive and modulate the broad-angle emitted light 204 to provide the modulated broad-angle emitted light 202′. Similarly, the light valve array 230 is configured to receive and modulate the directional emitted light 206 to provide the modulated directional emitted light 202″. In some embodiments, the light valve array 230 may be substantially similar to the array of light valves 130, described above with respect to the multi-user multiview display 100. For example, a light valve of the light valve array may comprise a liquid crystal light valve. Further, a size of a multibeam element 224 of the array of multibeam elements 224 may be comparable to a size of a light valve of the light valve array 230 (e.g., between one quarter and two times the light valve size), in some embodiments.

In various embodiments, the multiview backlight 220 is located between the broad-angle backlight 210 and the light valve array 230. The multiview backlight 220 may be positioned adjacent to the broad-angle backlight 210 and separated by a narrow gap. Further, in some embodiments, the multiview backlight 220 and the broad-angle backlight 210 are stacked such that a top surface of the broad-angle backlight 210 is substantially parallel to a bottom surface of the multiview backlight 220, in some embodiments. As such, the broad-angle emitted light 204 from the broad-angle backlight 210 may be emitted from a top surface of the broad-angle backlight 210 into and through the multiview backlight 220. According to various embodiments, the multiview backlight 220 is transparent to the broad-angle emitted light 204 emitted by the broad-angle backlight 210.

The multi-user multiview display system 200 illustrated in FIG. 6 further comprises a display controller 240. The display controller 240 is configured to control the multi-user multiview display system 200 to provide the multiview image (Multiview) when a position of a group of users of the multi-user multiview display system 200 is determined to be within a predefined viewing zone of the multi-user multiview display system 200. Otherwise, the display controller 240 is configured to control the multi-user multiview display system 200 to provide the 2D image (2D).

In some embodiments, the display controller 240 may be substantially similar to the display controller comprising the head tracker 140 of the multi-user multiview display 100, described above. In these embodiments, the display controller 240 comprising the head tracker to determine the position of users of the group of users. The display controller 240 is further configured to activate a light source of the multiview backlight 220 to provide directional light beams of the directional emitted light 206 and control the light valve array 230 to provide the multiview image (Multiview) when the user position is determined to be within the predefined viewing zone. Further, the display controller 240 is configured to otherwise activate a light source of the broad-angle backlight 210 to provide the broad-angle emitted light 204 and to control the light valve array 230 to provide the 2D image (2D) when the user position is determined to be outside of the predefined viewing zone.

In some embodiments, the display controller 240 is further configured to dynamically adjust the predefined viewing zone by changing a location of a multiview pixel of the light valve array relative to a location of a corresponding multibeam element 224 of the multibeam element array. In these embodiments, the predefined viewing zone is dynamically adjusted by the display controller 240 to keep the group of users within the predefined viewing zone. Further, the 2D image (2D) is provided only when the group of users is beyond an adjustment range of the predefined viewing zone, according to these embodiments.

In some embodiments, the head tracker of the display controller 240 may be substantially similar to the head tracker 140 of the above-described multi-user multiview display 100. For example, the head tracker may comprise the head tracker comprises one or more of a light detection and ranging sensor, a time-of-flight sensor, and a camera configured to determine the position of users of the group of users. According to various embodiments, the display controller 240 may be implemented using one or both of hardware-based circuits and software or firmware. In particular, the display controller 240 may be implemented one or both of as hardware comprising circuitry (e.g., an ASIC) and modules comprising software or firmware that are executed by a processor or similar circuitry to various operational characteristics of the display controller 240.

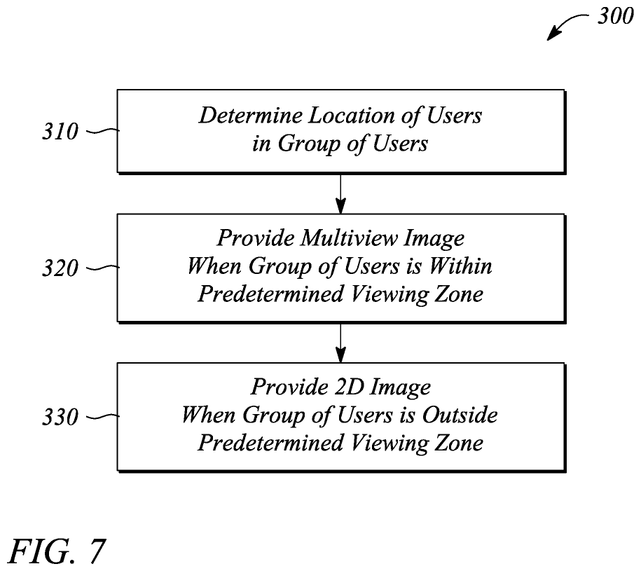

In accordance with other embodiments of the principles described herein, a method of multi-user multiview display operation is provided. FIG. 7 illustrates a flow chart of a method 300 of multi-user multiview display operation in an example, according to an embodiment consistent with the principles described herein. As illustrated in FIG. 7, the method 300 of multi-user multiview display operation comprises determining 310 a location of users in a group of users of the multi-user multiview display using a head tracker. In some embodiments, determining 310 a location of the users of the group of users comprise tracking a location of each of the users using the head tracker and comparing the location of each of the users of the group of users to the predefined viewing zone to determine if each of the users of the group of users are collectively within or outside of the predefined viewing zone. In some embodiments, the head tracker may be substantially similar to the head tracker 140 described above with respect to the multi-user multiview display 100. For example, the head tracker may comprise one or more of a light detection and ranging (LIDAR) sensor, a time-of-flight sensor, and a camera configured to determine the position of the users of the group of users. In other embodiments, the determining 310 a location of the users may comprises employing a display controller substantially similar to the display controller 240 of the multi-user multiview display system 200, described above.

The method 300 of multi-user multiview display operation illustrated in FIG. 7 further comprises providing 320 a multiview image when the location of the users of the group of users is determined to be within a predefined viewing zone of the multi-user display. The predefined viewing zone may be substantially similar to the predefined viewing zone I of the multi-user multiview display 100 illustrated in FIGS. 2A-2B, in some embodiments. For example, the multiview image may be provided by modulating directional emitted light from a multiview backlight using an array of light valves. In some embodiments, the multiview backlight and array of light valves may be substantially similar to the multiview backlight 120 and array of light valve 130 described above with respect to the multi-user multiview display 100. For example, the multiview backlight may comprise a light guide configured to guide light as guided light having a predetermined collimation factor. The multiview backlight may further comprise an array of multibeam elements are spaced apart from one another across the light guide, each multibeam element of the multibeam element array being configured to scatter out a portion of the guided light from the light guide as directional light beams of the directional emitted light. Further, a size of a multibeam element of the multibeam element array is between twenty-five percent and two hundred percent of a size of a light valve of the light valve array, in some embodiments.

The method 300 of multi-user multiview display operation further comprises providing 330 a two-dimensional (2D) image when the location of the users of the group of users is outside of the predefined viewing zone. According to various embodiments, the 2D image is provided 330 by modulating broad-angle emitted light from a broad-angle backlight using the light valve array. In some embodiments, the broad-angle backlight and broad-angle emitted light may be substantially similar to the broad-angle backlight 110 and broad-angle emitted light 102′, described above with respect to the multi-user multiview display 100.

In some embodiments (not illustrated), the method 300 of multi-user multiview display operation further comprises dynamically adjusting the predefined viewing zone by tilting the directional emitted light from the multiview backlight toward the group of users. In these embodiments, the predefined viewing zone may be dynamically adjusted to keep the users of the group of users within the predefined viewing zone. Further, the 2D image is provided only when the group of users is beyond an adjustment range of the predefined viewing zone, according to these embodiments. In some embodiments, tilting the directional emitted light comprises changing a location of a multiview pixel of the light valve array relative to a location of a corresponding multibeam element of the multibeam element array.

Thus, there have been described examples and embodiments of a multi-user multiview display, a multi-user multiview display system, and a method of multi-user multiview display operation that provide a multiview image when a group of users are within a predefined viewing zone and a 2D image when the group of users is outside of the predefined viewing zone. It should be understood that the above-described examples are merely illustrative of some of the many specific examples and embodiments that represent the principles described herein. Clearly, those skilled in the art can readily devise numerous other arrangements without departing from the scope as defined by the following claims.

What is claimed is:

1. A multi-user multiview display comprising:
a broad-angle backlight configured to provide broad-angle emitted light;
a multiview backlight configured to provide directional emitted light comprising directional light beams having directions corresponding to different view directions of a multiview image; and
an array of light valves configured to modulate the broad-angle emitted light to provide a two-dimensional (2D) image and to modulate the directional emitted light to provide the multiview image within a predefined viewing zone of the multi-user multiview display,
wherein the multi-user multiview display is configured to selectively provide either the multiview image when a group of users is within the predefined viewing zone or the 2D image when the group of users is outside of the predefined viewing zone.

2. The multi-user multiview display of claim 1, wherein the multiview backlight is disposed between the broad-angle backlight and the light valve array, the multiview backlight being optically transparent to the broad-angle emitted light.

3. The multi-user multiview display of claim 1, wherein the multiview backlight comprises:
a light guide configured to guide light as guided light having a predetermined collimation factor; and
an array of multibeam elements are spaced apart from one another across the light guide, each multibeam element of the multibeam element array being configured to scatter out a portion of the guided light from the light guide as the directional light beams of the directional emitted light,
wherein a size of a multibeam element of the multibeam element array is between twenty-five percent and two hundred percent of a size of a light valve of the light valve array.

4. The multi-user multiview display of claim 3, wherein a multibeam element of the multibeam element array comprises one or more of a diffraction grating configured to diffractively scatter out the guided light, a micro-reflective element configured to reflectively scatter out the guided light, and a micro-refractive element configured to refractively scatter out the guided light.

5. The multi-user multiview display of claim 4, wherein one or more of the diffraction grating, micro-reflective element, and micro-refractive element of the multibeam element comprises a plurality of sub-elements arranged within a boundary of the multibeam element.

6. The multi-user multiview display of claim 3, wherein the predefined viewing zone is configured to be dynamically adjusted by changing a location of a multiview pixel of the light valve array relative to a location of a corresponding multibeam element within the multibeam element array, the predefined viewing zone being dynamically adjusted to keep the group of users within the predefined viewing zone.

7. The multi-user multiview display of claim 6, wherein the 2D image is provided exclusively when the group of users is beyond an adjustment range of the predefined viewing zone.

8. The multi-user multiview display of claim 1, further comprising a head tracker configured to determine a position of users of the group of users relative to the predefined view zone of the multi-user multiview display and to selectively activate one of the broad-angle backlight or the multiview backlight based on the determined position, the multiview backlight being activated by the head tracker and the multiview image being provided when the group of users is determined to be within the predefined view zone, and the broad-angle backlight being activated by the head tracker and the 2D image being provided when the group of users is determined to be outside of the predefined view zone.

9. The multi-user multiview display of claim 8, wherein the head tracker comprises:
a camera configured to periodically capture an image of the group of users; and
an image processor configured to determine a position of the group of users within the periodically captured image to provide periodic location measurement of the group of users relative to the predefined viewing zone of the multi-user multiview display.

10. The multi-user multiview display of claim 9, wherein the head tracker further comprises:
a motion sensor configured to track a relative motion of the multi-user multiview display between the periodic location measurements to determine the relative motion of the multi-user multiview display,
wherein the relative motion is used to provide an estimate of the location of the group of users between the periodic location measurements.

11. A multi-user multiview display system comprising:
a broad-angle backlight configured to provide broad-angle emitted light;
a multiview backlight comprising an array of multibeam elements configured to provide directional emitted light comprising directional light beams having directions corresponding to different view directions of a multiview image;
an array of light valves configured to modulate the broad-angle emitted light to provide a two-dimensional (2D) image and to modulate the directional emitted light to provide the multiview image; and
a display controller configured to control the multi-user multiview display system to provide the multiview image when a position of a group of users of the multi-user multiview display system is determined to be within a predefined viewing zone of the multi-user multiview display system, the 2D image being provided otherwise.

12. The multi-user multiview display system of claim 11, wherein the multiview backlight further comprises:
a light guide configured to guide light as guided light,
wherein the array of multibeam elements are spaced apart from one another across the light guide, each multibeam element of the multibeam element array being configured to scatter out a portion of the guided light from the light guide as the directional light beams.

13. The multi-user multiview display system of claim 12, wherein the light guide is configured to guide the guided light according to a collimation factor as collimated guided light, and wherein a size of each multibeam element of the multibeam element array is between one quarter and two times a size of a light valve of the light valve array.

14. The multi-user multiview display system of claim 12, wherein each multibeam element of the multibeam element array comprises one or more of a diffraction grating configured to diffractively scatter out the guided light, a micro-reflective element configured to reflectively scatter out the guided light, and a micro-refractive element configured to refractively scatter out the guided light.

15. The multi-user multiview display system of claim 11, wherein the display controller comprises a head tracker configured to determine the position of users of the group of users, the display controller being further configured to:
activate a light source of the multiview backlight to provide directional light beams and control the light valve array to provide the multiview image when the user position is determined to be within the predefined viewing zone; and
to otherwise activate a light source of the broad-angle backlight to provide the broad-angle emitted light and to control the light valve array to provide the 2D image when the user position is determined to be outside of the predefined viewing zone.

16. The multi-user multiview display system of claim 11, wherein the display controller is further configured to dynamically adjust the predefined viewing zone by changing a location of a multiview pixel of the light valve array relative to a location of a corresponding multibeam element of the multibeam element array, the predefined viewing zone being dynamically adjusted by the display controller to keep the group of users within the predefined viewing zone and the 2D image being provided only when the group of users is beyond an adjustment range of the predefined viewing zone.

17. The multi-user multiview display system of claim 15, wherein the head tracker comprises one or more of a light detection and ranging sensor, a time-of-flight sensor, and a camera configured to determine the position of users of the group of users.

18. A method of operating a multi-user multiview display, the method comprising:
determining a location of users in a group of users of the multi-user multiview display using a head tracker;
providing a multiview image when the location of the users of the group of users is determined to be within a predefined viewing zone of the multi-user display, the multiview image being provided by modulating directional emitted light from a multiview backlight using an array of light valves; and
providing a two-dimensional (2D) image when the location of the users of the group of users is outside of the predefined viewing zone, the 2D image being provided by modulating broad-angle emitted light from a broad-angle backlight using the light valve array.

19. The method of operating a multi-user multiview display of claim 18, wherein determining a location of the users of the group of users comprises:
tracking a location of each of the users using the head tracker; and
comparing the location of each of the users of the group of users to the predefined viewing zone to determine if the users are collectively within or outside of the predefined viewing zone.

20. The method of operating a multi-user multiview display of claim 19, wherein the head tracker comprises one or more of a light detection and ranging (LIDAR) sensor, a time-of-flight sensor, and a camera configured to determine the location of the users of the group of users.

21. The method of operating a multi-user multiview display of claim 18, wherein multiview backlight comprises:
a light guide configured to guide light as guided light having a predetermined collimation factor; and
an array of multibeam elements are spaced apart from one another across the light guide, each multibeam element of the multibeam element array being configured to scatter out a portion of the guided light from the light guide as directional light beams of the directional emitted light,
wherein a size of a multibeam element of the multibeam element array is between twenty-five percent and two hundred percent of a size of a light valve of the light valve array.

22. The method of operating a multi-user multiview display of claim 18, the method further comprising:
dynamically adjusting the predefined viewing zone by tilting the directional emitted light from the multiview backlight toward the group of users, the predefined viewing zone being dynamically adjusted to keep the users of the group of users within the predefined viewing zone,
wherein the 2D image is provided only when the group of users is beyond an adjustment range of the predefined viewing zone.

23. The method of operating a multi-user multiview display of claim 22, wherein the multiview backlight comprises an array of multibeam elements, and wherein tilting the directional emitted light comprises changing a location of a multiview pixel of the light valve array relative to a location of a corresponding multibeam element of the multibeam element array.
